(19) United States
(12) Patent Application Publication
(10) Pub. No.: US 2022/0173671 A1
(43) Pub. Date: Jun. 2, 2022

(54) POWER CONVERSION DEVICE, DRIVE DEVICE, AND POWER STEERING DEVICE

(71) Applicant: NIDEC CORPORATION, Kyoto (JP)

(72) Inventors: Yoshiaki YAMASHITA, Kyoto (JP); Hiromitsu OHASHI, Kyoto (JP)

(21) Appl. No.: 17/601,049

(22) PCT Filed: Mar. 25, 2020
(86) PCT No.: PCT/JP2020/013243

§ 371 Date: Oct. 1, 2021

(30) Foreign Application Priority Data
Apr. 4, 2019 (JP) 2019-072218

(51) Int. Cl. H02M 7/5387; H02P 27/08; H02K 11/33; H02K 9/22; H02K 5/16; B62D 5/04

(52) U.S. Cl. CPC H02M 7/53871; H02P 27/08; B62D 5/04; H02K 9/227; H02K 5/16; H02K 11/33

(57) ABSTRACT

In an aspect of a power conversion device that converts power from a power source to supply the converted power to a motor, the power conversion device includes an inverter connected to a winding of the motor and including a first switching element that generates heat in association with an operation of power control and a second switching element that generates more heat than the first switching element in association with an operation of power control, and a substrate on which the first switching element and the second switching element are mounted, wherein a first element group including one or a plurality of the first switching elements and a second element group including one or a plurality of the second switching elements are alternately mounted on the substrate.

### CROSS-REFERENCE TO RELATED APPLICATIONS

This is the U.S. national stage of application No. PCT/JP2020/013243, filed on Mar. 25, 2020, and priority under 35 U.S.C. § 119(a) and 35 U.S.C. § 365(b) is claimed from Japanese Patent Application No. 2019-072218, filed on Apr. 4, 2019.

### FIELD OF THE INVENTION

The present invention relates to a power conversion device, a drive device, and a power steering device.

### BACKGROUND

In the related art, a drive system that drives a motor with an inverter is known. In such a drive system, since the inverter generates heat as the motor is driven, a structure for heat dissipation has been proposed.

For example, there is a configuration in which, in a rotating electric machine control device that controls energization of a rotating electric machine (motor) having a plurality of sets of windings, power conversion circuits of a plurality of systems are provided corresponding to the winding sets, and a specific circuit is different a normal circuit in a thickness of a heat sink of a corresponding portion.

However, in the related art techniques including the above-described technique, it is generally assumed that a plurality of inverters and switching elements in the inverters are in the same energized state, and an efficient heat dissipation structure in a case where heat generation amounts of the inverters and the switching elements in the inverters are different from each other is not considered.

### SUMMARY

In an aspect of a power conversion device according to the present invention that converts power from a power source to supply the converted power to a motor, the power conversion device includes an inverter connected to a winding of the motor and including a first switching element that generates heat in association with an operation of power control and a second switching element that generates more heat than the first switching element in association with an operation of power control, and a substrate on which the first switching element and the second switching element are mounted, wherein a first element group including one or a plurality of the first switching elements and a second element group including one or a plurality of the second switching elements are alternately mounted on the substrate. Further, an aspect of a drive device according to the present invention includes the power conversion device described above and a motor to which the power converted by the power conversion device is supplied.

Further, an aspect of a power steering device according to the present invention includes the power conversion device described above, a motor to which the power converted by the power conversion device is supplied, and a power steering mechanism to be driven by the motor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating a block configuration of a motor drive unit according to the present embodiment;

FIG. 2 is a diagram schematically illustrating a circuit configuration of the motor drive unit according to the present embodiment;

FIG. 3 is a diagram illustrating current values flowing through the coils of respective phases of a motor;

FIG. 4 is a diagram schematically illustrating a state in which a current flows from one end to the other end of a winding of a motor under PWM control and a between-ON/OFF operation;

FIG. 5 is a diagram schematically illustrating a state in which a current flows from the other end to one end of the winding of the motor under the PWM control and the between-ON/OFF operation;

FIG. 6 is a diagram illustrating a heat generation state of each switching element in the motor drive unit;

FIG. 7 is an exploded perspective view of the motor drive unit;

FIG. 8 is a schematic cross-sectional view of the motor drive unit;

FIG. 9 is a diagram schematically illustrating mounting positions of the switching element;

FIG. 10 is a diagram schematically illustrating mounting positions of the switching elements in the modification;

FIG. 11 is a diagram schematically illustrating mounting positions of the switching elements in another modification;

FIG. 12 is a diagram schematically illustrating mounting positions of the switching elements in still another modification;

FIG. 13 is a diagram illustrating a modification in which positions of a low-heat generating switching element and a high-heat generating switching element on a circuit are different;

FIG. 14 is a diagram schematically illustrating an example of a mounting position of the switching elements in the modification illustrated in FIG. 13;

FIG. 15 is a diagram schematically illustrating an example of linear mounting positions of the switching elements in the modification illustrated in FIG. 13;

FIG. 16 is a diagram schematically illustrating an example of a two-dimensional mounting position of the switching elements in the modification illustrated in FIG. 13;

FIG. 17 is a diagram schematically illustrating another example of two-dimensional mounting positions of the switching elements in the modification illustrated in FIG. 13; and

FIG. 18 is a diagram schematically illustrating a configuration of an electric power steering device according to the present embodiment.

### DETAILED DESCRIPTION

Hereinafter, embodiments of a power conversion device, a drive device, and a power steering device of the present disclosure will be described in detail with reference to the accompanying drawings. However, in order to avoid the following description from being unnecessarily redundant and to make it easier for those skilled in the art to understand, a detailed description more than necessary may be omitted. For example, detailed explanation of already well-known matters and redundant explanation on substantially the same configuration may be omitted.

In the present specification, an embodiment of the present disclosure will be described by illustrating a power conversion device which converts power from a power source to supply the converted power to a three-phase motor including three-phase (U-phase, V-phase, and W-phase) windings (referred to as “coils” in some cases). However, a power conversion device which converts power from a power source to supply the converted power to an n-phase motor including n-phase (n is an integer of 4 or more) windings such as four-phase or five-phase windings is also within the scope of the present disclosure.

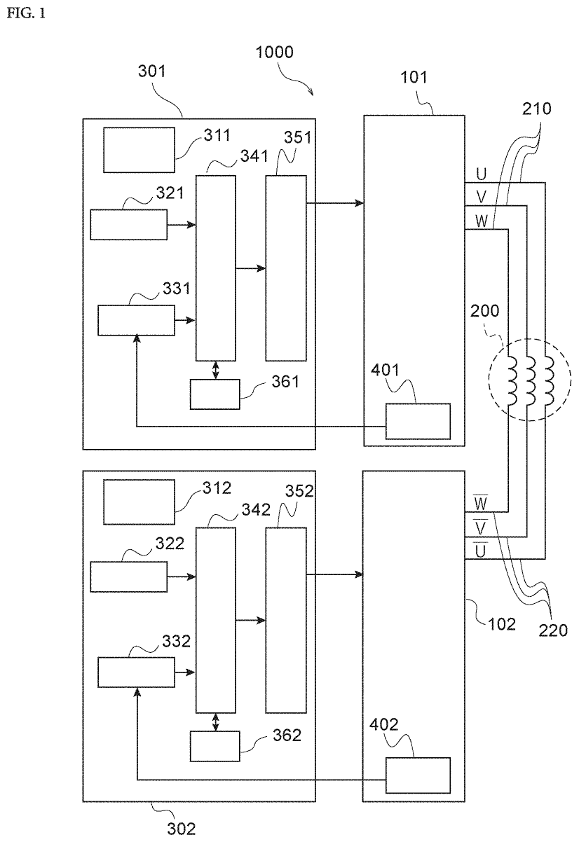

FIG. 1 is a diagram schematically illustrating a block configuration of a motor drive unit 1000 according to the present embodiment. The motor drive unit 1000 includes inverters 101 and 102, a motor 200, and control circuits 301 and 302.

In the present specification, the motor drive unit 1000 including the motor 200 as a component will be described. The motor drive unit 1000 including the motor 200 corresponds to an example of a drive device of the present invention. However, the motor drive unit 1000 may be a device for driving the motor 200 from which the motor 200 as a component is omitted. The motor drive unit 1000 from which the motor 200 is omitted corresponds to an example of a power conversion device according to the present invention.

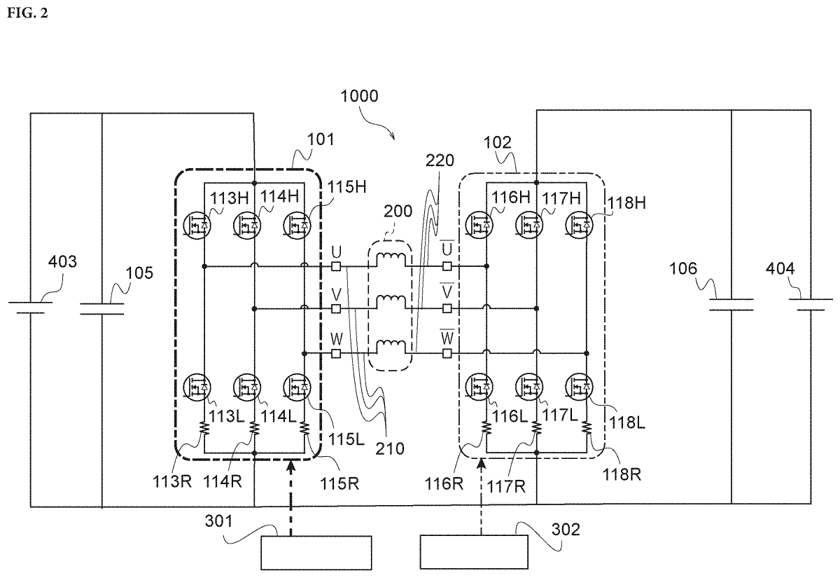

The motor drive unit 1000 converts power from a power source (403 and 404 in FIG. 2) by the two inverters 101 and 102 to supply the converted power to the motor 200. For example, the inverters 101 and 102 can convert DC power into three-phase AC power having U-phase, V-phase, and W-phase pseudo sine waves. The two inverters 101 and 102 respectively include current sensors 401 and 402, respectively.

The motor 200 is, for example, a three-phase AC motor. The motor 200 has U-phase, V-phase and W-phase coils. The winding method of the coil is, for example, concentrated winding or distributed winding.

The first inverter 101 is connected to one end 210 of the coil of the motor 200 and applies a drive voltage to the one end 210, and the second inverter 102 is connected to the other end 220 of the coil of the motor 200 and applies a drive voltage to the other end 220. In the present specification, “connection” between parts (components) means an electrical connection unless otherwise specified.

The control circuits 301 and 302 include microcontrollers 341 and 342 and the like as described in detail below. The control circuits 301 and 302 control the drive current of the motor 200 based on input signals from the current sensors 401 and 402 and the angle sensors 321 and 322. Specifically, the control circuits 301 and 302 control the drive current of the motor 200 by controlling the operations of the two inverters 101 and 102. As a control method of controlling the drive current by the control circuits 301 and 302, a control method selected from vector control and direct torque control (DTC) is used, for example. A specific circuit configuration of the motor drive unit 1000 will be described with reference to FIG. 2. FIG. 2 schematically illustrates a circuit configuration of the motor drive unit 1000 according to the present embodiment.

The motor drive unit 1000 is connected to a first power source 403 and a second power source 404 that are independent of each other. The power sources 403 and 404 generate a predetermined power source voltage (for example, 12 V). As each of the power sources 403 and 404, for example, a DC power source is used. However, each of the power sources 403 and 404 may be an AC-DC converter or a DC-DC converter, or may be a battery (storage battery). In FIG. 2, the first power source 403 for the first inverter 101 and the second power source 404 for the second inverter 102 are shown as an example, but the motor drive unit 1000 may be connected to a single power source shared by the first inverter 101 and the second inverter 102. Further, the motor drive unit 1000 may have a power source inside.

The motor drive unit 1000 includes a first system corresponding to one end 210 side of the motor 200 and a second system corresponding to the other end 220 side of the motor 200. The first system includes the first inverter 101 and a first control circuit 301. The second system includes the second inverter 102 and a second control circuit 302. The inverter 101 and the control circuit 301 of the first system are supplied with power from the first power source 403. The inverter 102 and the control circuit 302 of the second system are supplied with power from the second power source 404.

In FIG. 2, the first control circuit 301 for the first inverter 101 and the second control circuit 302 for the second inverter 102 shown as an example, in but the motor drive unit 1000, the first inverter 101 and the second inverter 102 may be controlled by a single control circuit.

The first inverter 101 includes a bridge circuit having three legs. Each leg of the first inverter 101 includes a high-side switching element connected between the power source and the motor 200, and a low-side switching element connected between the motor 200 and the ground. Specifically, the U-phase leg includes a high-side switching element 113H and a low-side switching element 113L. The V-phase leg includes a high-side switching element 114H and a low-side switching element 114L. The W-phase leg includes a high-side switching element 115H and a low-side switching element 115L.

As the switching element, a field effect transistor (MOSFET or the like) or an insulated gate bipolar transistor (IGBT of the like) is used, for example. In addition, a power transistor other than a silicon material may be used as the switching element. When the switching element is an IGBT, a diode (freewheel) is connected in antiparallel with the switching element.

The first inverter 101 includes, at respective legs, shunt resistors 113R, 114R, and 115R as the current sensor 401 (refer to FIG. 1) that detects current flowing in the U-phase, V-phase, and W-phase windings, for example. The current sensor 401 includes a current detection circuit (not illustrated) which detects current flowing in the respective shunt resistors. For example, the shunt resistors may be connected between the low-side switching elements 113L, 114L and 115L and the ground. A resistance value of each of the shunt resistors is about 0.5 mω to 1.0 mω, for example.

The number of the shunt resistors may not be three. For example, the two shunt resistors 113R and 114R for U-phase and V-phase, the two shunt resistors 114R and 115R for V-phase and W-phase, or the two shunt resistors 113R and 115R for U-phase and W-phase may be used. The number of the shunt resistors used and the arrangement of the shunt resistors are appropriately determined in consideration of product cost, design specifications, and the like.

The second inverter 102 includes a bridge circuit having three legs. Each leg of the second inverter 102 includes a high-side switching element connected between the power source and the motor 200, and a low-side switching element connected between the motor 200 and the ground. Specifically, the U-phase leg includes a high-side switching element 116H and a low-side switching element 116L. The V-phase leg includes a high-side switching element 117H and a low-side switching element 117L. The W-phase leg includes a high-side switching element 118H and a low-side switching element 118L. As in the first inverter 101, the second inverter 102 includes shunt resistors 116R, 117R and 118R, for example.

The motor drive unit 1000 includes capacitors 105 and 106. Each of the capacitors 105 and 106 is a so-called smoothing capacitor which stabilizes the power source voltage and suppresses torque ripple by absorbing the recirculation current generated by the motor 200. Each of the capacitors 105 and 106 is an electrolytic capacitor, for example, and the capacitance and the number of capacitors to be used are appropriately determined in accordance with design specifications and the like.

Refer to FIG. 1, again. The control circuits 301 and 302 include power supply circuits 311 and 312, the angle sensors 321 and 322, input circuits 331 and 332, the microcontrollers 341 and 342, drive circuits 351 and 352, and ROMs 361 and 362, for example. The control circuits 301 and 302 are connected to the inverters 101 and 102. Then, the first control circuit 301 controls the first inverter 101, and the second control circuit 302 controls the second inverter 102.

The control circuits 301 and 302 can achieve closed loop control by controlling a targeted position (rotation angle), a targeted rotation speed, a targeted current, and the like of a rotor. The rotation speed is obtained by differentiating the rotation angle (rad) with time and is expressed as the number of times of rotation (rpm) of the rotor per unit time (for example, one minute), for example. The control circuits 301 and 302 can also control targeted motor torque. The control circuits 301 and 302 may include a torque sensor for torque control, but torque can be controlled even without the torque sensor. Also, a sensorless algorithm may be provided instead of the angle sensors 321 and 322. In the present embodiment, torque control is performed by one of the two control circuits 301 and 302 (for example, the second control circuit 302). The power supply circuits 311 and 312 generate DC voltage (for example, 3 V and 5 V) required for each block in the control circuits 301 and 302.

The angle sensors 321 and 322 are resolvers or Hall ICs, for example. The angle sensors 321 and 322 are also achieved by a combination of an MR sensor having a magnetoresistive (MR) element and a sensor magnet. The angle sensors 321 and 322 detect a rotation angle of the rotor of the motor 200 and output a rotation signal representing the detected rotation angle to the microcontrollers 341 and 342. The angle sensors 321 and 322 may be omitted depending on the motor control method (for example, sensorless control).

The input circuits 331 and 332 receive motor current values (hereinafter, referred to as an “actual current value”) detected by the current sensors 401 and 402. The input circuits 331 and 332 convert the level of the actual current value into the input level of the microcontrollers 341 and 342 as needed to output the actual current value to the microcontrollers 341 and 342. The input circuits 331 and 332 are analog-digital conversion circuits.

The microcontrollers 341 and 342 receive the rotation signal of the rotor detected by the angle sensors 321 and 322 and the actual current value output from the input circuits 331 and 332. Among the two microcontrollers 341 and 342, for example, the microcontroller 342 of the second control circuit 302 that performs torque control sets a target current value according to an actual current value, a rotation signal of the rotor, and the like, and generates a PWM signal to output the generated PWM signal to the drive circuit 352. For example, the microcontroller 342 of the second control circuit 302 generates a PWM signal for controlling a switching operation (turn-on or turn-off) of each switching element in the second inverter 102.

On the other hand, for example, the first control circuit 301 of the two microcontrollers 341 and 342 generates an ON/OFF signal for controlling the switching operation of each switching element in first inverter 101 to output the generated ON/OFF signal to the drive circuit 351. By the control by the ON/OFF signal, the switching element of the first inverter 101 maintains either the ON state or the OFF state while the switching element in the second inverter 102 performs the switching operation a plurality of times by the PWM control, and part of the plurality of switching elements in the first inverter 101 is turned on and the other part is turned off. Such an operation in the switching element of the first inverter 101 is hereinafter referred to as a between-ON/OFF operation.

The sharing of the control in the two control circuits 301 and 302 and the two microcontrollers 341 and 342 and the sharing of the operation in the two inverters 101 and 102 may be switched between the first system and the second system. However, for convenience of description, the following description will be made on the assumption that the between-ON/OFF operation is performed in the first system and the PWM control is performed in the second system.

Each of the drive circuits 351 and 352 is typically a gate driver. Each of the drive circuits 351 and 352 generates a control signal (for example, a gate control signal) for controlling a switching operation of each switching element in the first inverter 101 and the second inverter 102 in accordance with the PWM signal and the ON/OFF signal, and provides the generated control signal to each switching element. The microcontrollers 341 and 342 may have the functions of the drive circuits 351 and 352. In this case, the drive circuits 351 and 352 are omitted.

The ROMs 361 and 362 are writable memories (for example, PROMs), rewritable memories (for example, flash memories), or read-only memories, for example. The ROMs 361 and 362 store control programs including command groups for causing the microcontrollers 341 and 342 to control the inverters 101 and 102, and the like. For example, the control program is once developed in the RAM (not shown) at the time of booting. Hereinafter, a specific example of the operation of the motor drive unit 1000 will be described, and a specific example of the operation of the inverters 101 and 102 will be mainly described.

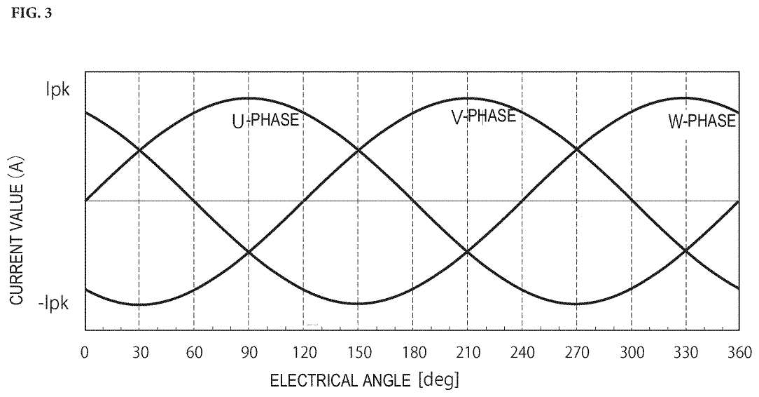

The control circuits 301 and 302 drive the motor 200 by performing three-phase energization control using the first inverter 101 and second inverter 102. Specifically, the control circuits 301 and 302 perform three-phase energization control by performing switching control on the switching element of the first inverter 101 and the switching element of the second inverter 102. FIG. 3 is a diagram illustrating current values flowing through the respective coils of the respective phases of the motor 200.

FIG. 3 illustrates current waveforms (sine waves) obtained by plotting current values flowing in the U-phase, V-phase, and W-phase coils of the motor 200 when the first inverter 101 and the second inverter 102 are controlled in accordance with the three-phase energization control. The horizontal axis of FIG. 3 indicates the motor electrical angle (deg), and the vertical axis indicates the current value (A). Iₚₖ represents a maximum current value (peak current value) of each phase. The inverters 101 and 102 can also drive the motor 200 using, for example, a square wave, besides the sine wave illustrated in FIG. 3.

The current waveform illustrated in FIG. 3 is generated when a voltage having a waveform corresponding to the current waveform is applied to the motor 200. The amplitude of the voltage waveform is generated when the switching element of the second inverter 102 performs switching at a high speed such as 20 kHz by PWM control. In addition, the positive and negative of the voltage waveform are caused by switching between an ON state and an OFF state of the between-ON/OFF operation in each switching element of the first inverter 101 and switching of an element that performs switching by PWM control among the switching elements of the second inverter 102.

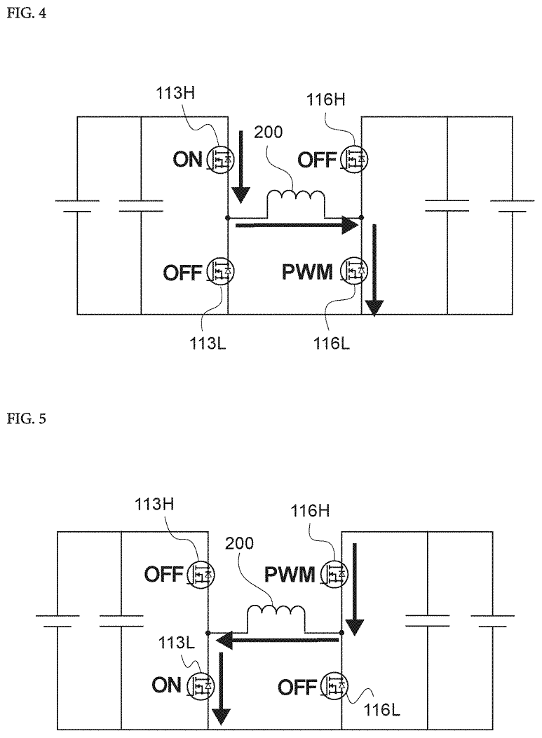

FIGS. 4 and 5 are diagrams schematically illustrating the switching operation under the PWM control and the between-ON/OFF operation. FIG. 4 illustrates a state in which the current flows from one end to the other end of the winding of the motor, and FIG. 5 illustrates a state in which the current flows from the other end to the one end of the winding of the motor.

FIGS. 4 and 5 illustrate, for example, the U-phase leg among the legs of the inverters 101 and 102. As described above, the U-phase leg includes the high-side switching element 113H and the low-side switching element 113L on the first inverter 101 and the high-side switching element 116H and the low-side switching element 116L on the second inverter 102.

The high-side switching element 113H and the low-side switching element 113L on the first inverter 101 are not simultaneously turned on, and when one is turned on, the other is turned off. Similarly, the high-side switching element 116H and the low-side switching element 116L on the second inverter 102 are not simultaneously turned on.

When a current flows from one end to the other end of the winding of the motor 200 as indicated by an arrow in FIG. 4, in the first inverter 101, the high-side switching element 113H is turned on, and the low-side switching element 113L is turned off. In the second inverter 102, the high-side switching element 116H is turned off, and the low-side switching element 116L performs the switching operation according to the PWM control.

When a current flows from the other end to the one end of the winding of the motor 200 as indicated by an arrow in FIG. 5, in the first inverter 101, the high-side switching element 113H is turned off, and the low-side switching element 113L is turned on. In the second inverter 102, the high-side switching element 116H performs the switching operation according to the PWM control, and the low-side switching element 116L is turned off.

For example, in a case where the current waveform illustrated in FIG. 3 is used, the state illustrated in FIG. 4 and the state illustrated in FIG. 5 are repeated. Each of the switching elements 113H, 113L, 116H, and 116L generates heat in accordance with the switching operation of the power control. For this reason, the switching elements 116H and 116L of the second inverter 102 that frequently perform the switching operation according to the PWM control generate more heat than the switching elements 113H and 113L of the first inverter 101 that perform the between-ON/OFF operation as average heat generation during the normal operation.

As illustrated in FIG. 4, the high-side switching element 113H that is turned on by the between-ON/OFF operation is connected to the low-side switching element 116L via the winding of motor 200, and a current controlled by switching the low-side switching element 116L flows. As illustrated in FIG. 5, the low-side switching element 113L that is turned on by the between-ON/OFF operation is connected to the high-side switching element 116H via the winding of motor 200, and a current controlled by switching the high-side switching element 116H flows. Since the switching operation is different between one side and the other side across the winding of the motor 200, heat generation sharing between the switching elements is realized.

As compared with the case where, in the conventional PWM control, both switching elements connected to both ends of the winding of the motor 200 frequently perform the switching operation according to the PWM control, in the present embodiment, the between-ON/OFF operation is performed on one side of the winding of the motor 200, so that the amount of heat generated by the motor drive unit 1000 in the present embodiment is smaller than that in the conventional case.

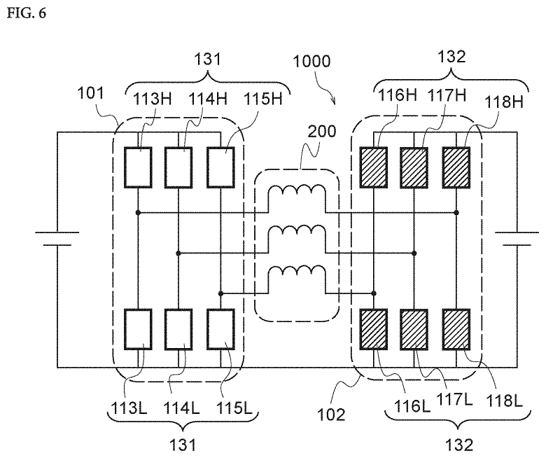

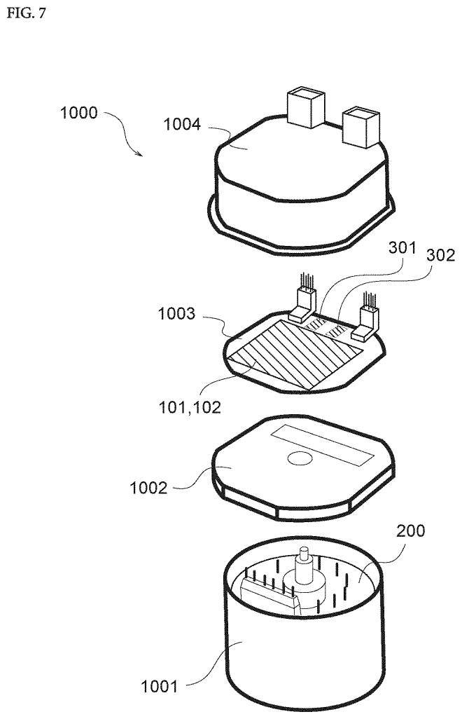

FIG. 6 is a diagram illustrating a heat generation state of each switching element in the motor drive unit 1000.

In the motor drive unit 1000 of the present embodiment, of the two inverters 101 and 102 connected to both ends of the motor 200, the six switching elements 116H, 117H, 118H, 116L, 117L, and 118L provided in the second inverter 102 are high-heat generating switching elements 132, indicated by hatching in the drawing, that operate according to PWM control. In addition, of the two inverters 101 and 102, the six switching elements 113H, 114H, 115H, 113L, 114L, and 115L provided in the first inverter 101 are low-heat generating switching elements 131, indicated by open frames in the drawing, that perform the between-ON/OFF operation.

In other words, the low-heat generating switching element 131 is provided in one of the first inverter 101 and the second inverter 102, and the high-heat generating switching element 132 is provided in the other opposite to the one. As described above, in the motor drive unit 1000 of the present embodiment, heat generation is shared in inverter unit.

Furthermore, the motor drive unit 1000 of the present embodiment has a hardware structure with high heat dissipation efficiency in consideration of including both the high-heat generating switching element 132 and the low-heat generating switching element 131.

The reason why the amount of heat generated in the switching element is different is not only that the frequency of switching is different as described above, but also that the applied voltage is different, that the composition is different, that the resistance of the reflux diode is different, and the like. Even when the amount of heat generation of the switching element is different for any reason, a hardware structure with high heat dissipation efficiency described below can be applied.

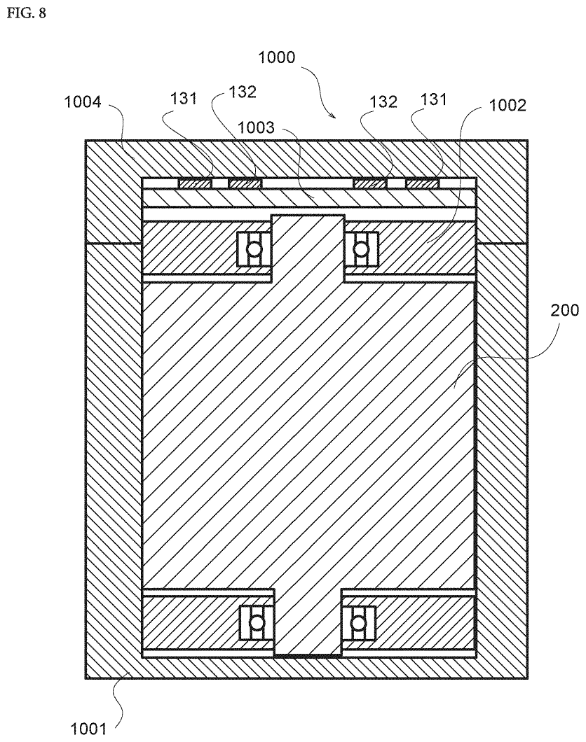

Next, a hardware configuration of the motor drive unit 1000 will be described. FIG. 7 is an exploded perspective view of the motor drive unit 1000, and FIG. 8 is a schematic cross-sectional view of the motor drive unit 1000.

The motor drive unit 1000 includes a lower housing 1001, the motor 200, a bearing holder 1002, a substrate 1003, and an upper housing 1004.

The lower housing 1001 and the upper housing 1004 house the motor 200, the bearing holder 1002, and the substrate 1003 therein and integrated. Thus, the motor drive unit 1000 is assembled as a so-called mechanically and electrically integrated motor. Two inverters 101 and 102 and two control circuits 301, 302 that control the inverters 101 and 102 are mounted on the substrate 1003.

The upper housing 1004 serves as a heat sink that is in direct or indirect contact with both the low-heat generating switching element 131 and the high-heat generating switching element 132 to dissipate heat from the entire switching elements 131 and 132. This heat sink achieves efficient heat dissipation in the entire switching elements 131 and 132. The bearing holder 1002 is a holder of a bearing that holds a rotation shaft of the motor 200.

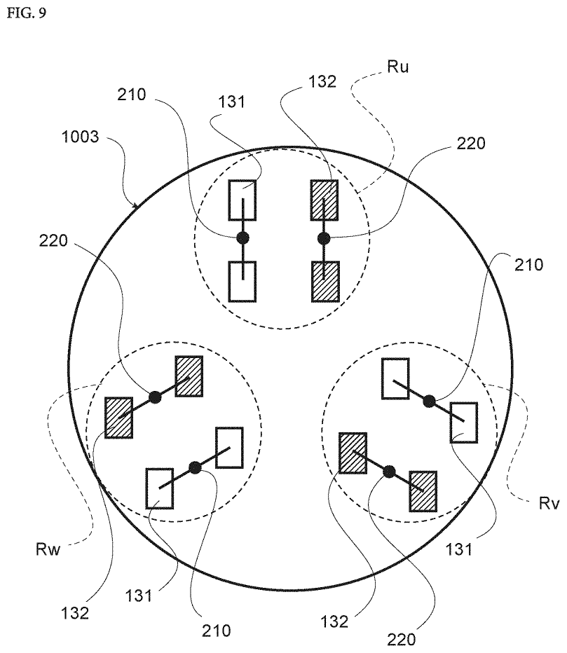

In the present embodiment, the upper housing 1004 serves as a heat sink, but more generally, it is desirable that at least one of the housing that accommodates the motor 200 and the holder of the bearing that holds the rotation shaft of the motor 200 serves as a heat sink that is in direct or indirect contact with both the low-heat generating switching element 131 and the high-heat generating switching element 132 to dissipate heat. At least one of the housing and the bearing holder serves as a heat sink, which contributes to reduction the number of components and space saving. Next, specific examples of mounting positions of the switching elements 131 and 132 will be described. FIG. 9 is a diagram schematically illustrating mounting positions of the switching elements 131 and 132.

FIG. 9 illustrates the surface of the substrate 1003. The U-phase switching elements 131 and 132 are collectively mounted on the U-phase mounting position Ru, the V-phase switching elements 131 and 132 are collectively mounted on the V-phase mounting position Rv, and the W-phase switching elements 131 and 132 are collectively mounted on the W-phase mounting position Rw. Then, the phases are isotropically mounted to each other.

The three mounting positions Ru, Rv, and Rw are annularly disposed along the outer edge of the substrate 1003. In the four switching elements 131 and 132 mounted on each of the mounting positions Ru, Rv, and Rw, both the arrangement of the low-heat generating switching elements 131 and the arrangement of the high-heat generating switching elements 132 are directed from the outer edge to the central portion of the substrate 1003. The low-heat generating switching element 131 and the high-heat generating switching element 132 are disposed in an annular direction along the outer edge of the substrate 1003.

When viewed in an annular direction around the three mounting positions Ru, Rv, and Rw along the outer edge of the substrate 1003, the low-heat generating switching element 131 and the high-heat generating switching element 132 are alternately mounted. The order of mounting in the annular direction is alternate mounting for the individual switching elements 131 and 132 and for the set of low-heat generating switching elements 131 and the set of high-heat generating switching elements 132 in each phase.

The set of low-heat generating switching elements 131 is a set of a high-side switching element and a low-side switching element mounted with a connection point at which one end 210 of the coil of the motor is connected to substrate 1003 mounted therebetween. The set of high-heat generating switching elements 132 is a set of a high-side switching element and a low-side switching element with a connection point at which the other end 220 of the coil of the motor is connected to the substrate 1003 mounted therebetween.

The mounting arrangement illustrated in FIG. 9 corresponds to an example of an arrangement in which a first element group including one or a plurality of low-heat generating switching elements 131 and a second element group including one or a plurality of high-heat generating switching elements 132 are alternately mounted on the substrate 1003. By alternately mounting the first element group and the second element group, heat distribution is leveled on the substrate 1003, and heat is efficiently dissipated via a heat sink or the like. In addition, the mounting arrangement illustrated in FIG. 9 corresponds to an example of an arrangement in which the first element group and the second element group are alternately arranged and mounted along the annular arrangement direction on the substrate 1003. By mounting the groups in such an annular arrangement, an isotropic heat generation distribution is obtained on the substrate 1003, and heat dissipation efficiency is good. Specifically, when the high-heat generating switching element 132 included in the second element group is a switching element that performs switching by PWM control, heat generated by the switching of the PWM control is efficiently dissipated. In addition, since the heat dissipation efficiency in the circuit on the substrate 1003 corresponding to the power conversion device is high, miniaturization and high output of the mechanically and electrically integrated motor corresponding to the drive device are realized.

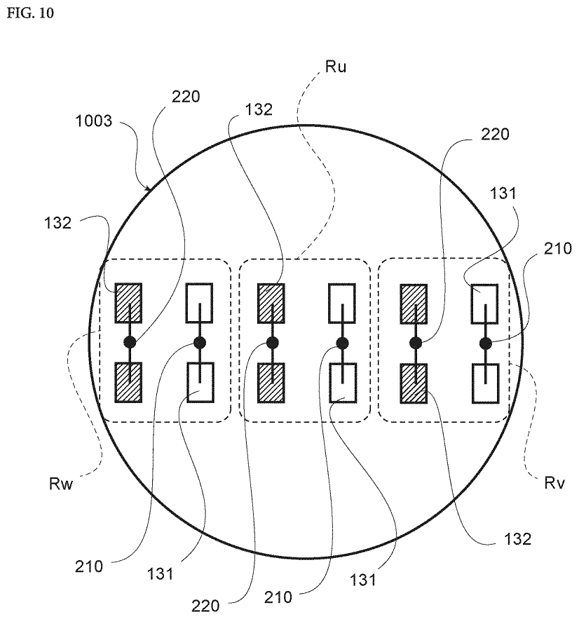

Modifications of mounting positions of the switching elements 131 and 132 will be described below. Any of the modifications described below corresponds to an example of an arrangement in which the first element group and the second element group are alternately mounted on the substrate 1003. FIG. 10 is a diagram schematically illustrating mounting positions of the switching elements 131 and 132 in the modification.

Also in the modification illustrated in FIG. 10, the U-phase switching elements 131 and 132 are collectively mounted on the U-phase mounting position Ru, the V-phase switching elements 131 and 132 are collectively mounted on the V-phase mounting position Rv, and the W-phase switching elements 131 and 132 are collectively mounted on the W-phase mounting position Rw. The three mounting positions Ru, Rv, and Rw are disposed in a linear direction (that is, the left-right direction in the drawing) on the substrate 1003.

In the four switching elements 131 and 132 mounted on each of the mounting positions Ru, Rv, and Rw, the arrangement of the low-heat generating switching element 131 and the high-heat generating switching element 132 is oriented in the linear direction in which the three mounting positions Ru, Rv, and Rw are disposed. Both the arrangement of the low-heat generating switching elements 131 and the arrangement of the high-heat generating switching elements 132 are oriented in a direction intersecting the linear direction (that is, the vertical direction in the drawing).

When viewed in the linear direction, the low-heat generating switching element 131 and the high-heat generating switching element 132 are alternately mounted. The order of mounting in the linear direction is alternate mounting for the individual switching elements 131 and 132, and for the set of low-heat generating switching elements 131 and the set of high-heat generating switching elements 132 in each phase. That is, the modification illustrated in FIG. 10 corresponds to an example of an arrangement in which the first element group and the second element group are alternately arranged and mounted along the linear arrangement direction on the substrate 1003. By such linear arrangement mounting, the heat radiation amount is leveled in the linear direction.

Also in the modification illustrated in FIG. 10, the set of low-heat generating switching elements 131 is a set of a high-side switching element and a low-side switching element mounted with a connection point at which one end 210 of the coil of the motor is connected to the substrate 1003 mounted therebetween. The set of high-heat generating switching elements 132 is a set of a high-side switching element and a low-side switching element with a connection point at which the other end 220 of the coil of the motor is connected to the substrate 1003 mounted therebetween.

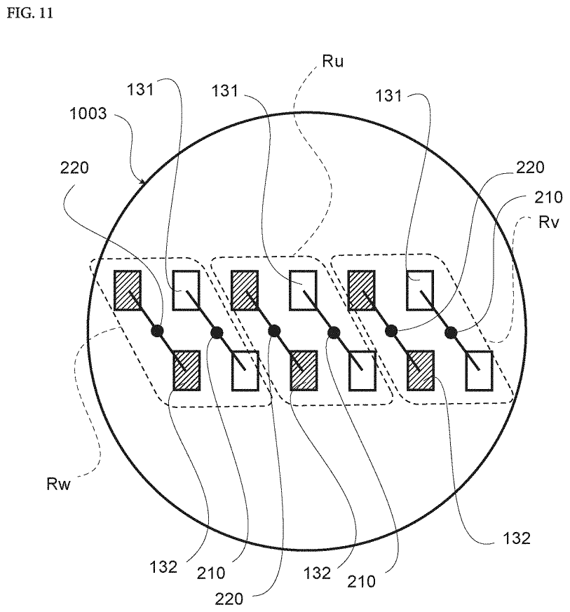

When the low-heat generating switching element 131 and the high-heat generating switching element 132 are alternately mounted on the substrate 1003 as in the modification illustrated in FIG. 10, heat distribution is leveled on the substrate 1003, and heat is efficiently dissipated via a heat sink or the like. FIG. 11 is a diagram schematically illustrating mounting positions of the switching elements 131 and 132 in another modification.

Also in the modification illustrated in FIG. 11, the U-phase switching elements 131 and 132 are collectively mounted on the U-phase mounting position Ru, the V-phase switching elements 131 and 132 are collectively mounted on the V-phase mounting position Rv, and the W-phase switching elements 131 and 132 are collectively mounted on the W-phase mounting position Rw. In addition, as in the modification of FIG. 10, in the modification illustrated in FIG. 11, the three mounting positions Ru, Rv, and Rw are disposed in a linear direction (that is, the left-right direction in the drawing) on the substrate 1003.

Also in the modification illustrated in FIG. 11, in the four switching elements 131 and 132 mounted on each of the mounting positions Ru, Rv, and Rw, the arrangement of the low-heat generating switching element 131 and the high-heat generating switching element 132 is oriented in the linear direction in which the three mounting positions Ru, Rv, and Rw are disposed. On the other hand, the arrangement of the low-heat generating switching elements 131 and the arrangement of the high-heat generating switching elements 132 in each phase are both oriented in an oblique direction intersecting the linear direction. As a result, the low-heat generating switching element 131 and the high-heat generating switching element 132 are alternately mounted in the left-right direction in the drawing, and the low-heat generating switching element 131 and the high-heat generating switching element 132 are adjacent to each other in the vertical direction in the drawing.

The set of low-heat generating switching elements 131 disposed in an oblique direction in the drawing is a set of a high-side switching element and a low-side switching element mounted with a connection point at which one end of the coil of the motor is connected to substrate 1003 mounted therebetween. The set of high-heat generating switching elements 132 disposed in an oblique direction in the drawing is a set of a high-side switching element and a low-side switching element mounted with a connection point at which the other end of the coil of the motor is connected to the substrate 1003 mounted therebetween.

When viewed in the linear direction in which the three mounting positions Ru, Rv, and Rw are disposed, the low-heat generating switching element 131 and the high-heat generating switching element 132 are alternately mounted. The order of mounting in the linear direction is alternate mounting for the individual switching elements 131 and 132, and for the set of low-heat generating switching elements 131 and the set of high-heat generating switching elements 132 in each phase. That is, the modification illustrated in FIG. 11 also corresponds to an example of an arrangement in which the first element group and the second element group are alternately arranged and mounted along the linear arrangement direction on the substrate 1003.

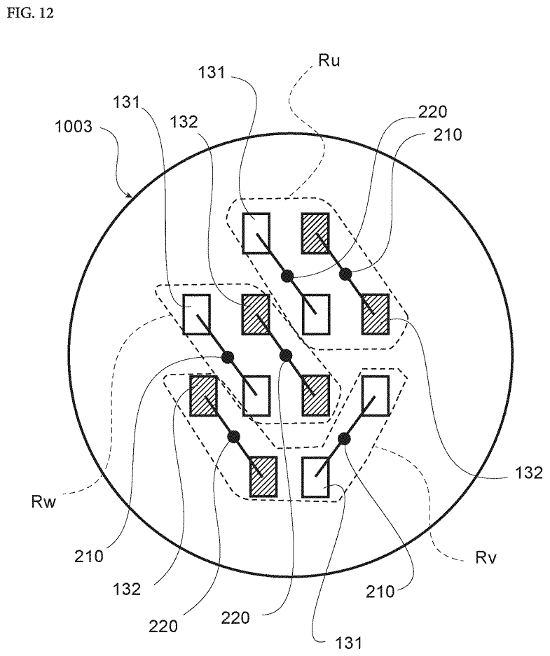

In the modification illustrated in FIG. 11, the low-heat generating switching element 131 and the high-heat generating switching element 132 are alternately mounted on substrate 1003 in the left-right direction in the drawing, and the low-heat generating switching element 131 and the high-heat generating switching element 132 are adjacent to each other in the vertical direction in the drawing, so that the heat distribution on substrate 1003 is more uniform than that in the modification illustrated in FIG. 10. FIG. 12 is a diagram schematically illustrating mounting positions of switching elements 131 and 132 according to still another modification.

In the modification illustrated in FIG. 12, the mounting positions Ru, Rv, and Rw of the switching elements 131 and 132 of the U-phase, the V-phase, and the W-phase are not uniform on the substrate 1003. However, focusing on individual switching elements 131 and 132, the low-heat generating switching elements 131 and the high-heat generating switching elements 132 are alternately mounted in the left-right direction of the drawing and the vertical direction of the drawing. That is, the modification corresponds to an example of a mounting arrangement in which the first element group and the second element group are alternately arrayed and mounted in a two-dimensional array on the substrate 1003, and in this example, the first element group and the second element group include one switching element 131 and one switching element 132, respectively. With the mounting arrangement in such a two-dimensional array, heat is efficiently leveled over the entire array.

In the modification illustrated in FIG. 12, the distance between the low-heat generating switching element 131 and the high-heat generating switching element 132 between the different phases is shorter than the distance between the high-heat generating switching elements 132 in the different phases. Therefore, the heat on the high heat generation side and the heat on the low heat generation side in its vicinity are efficiently leveled.

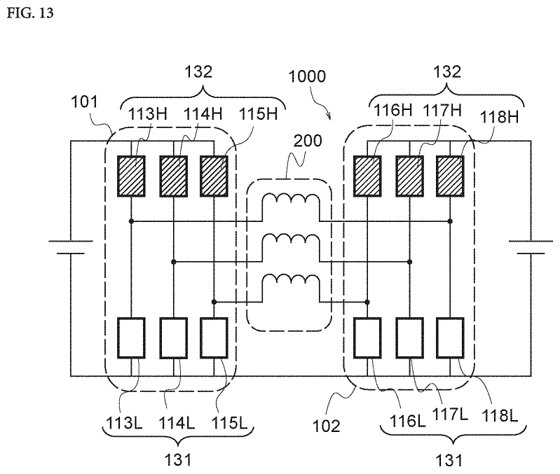

With the mounting arrangement of the switching elements 131 and 132 in the modification illustrated in FIG. 12, the heat distribution is further leveled on the substrate 1003 than that in the modifications illustrated in FIGS. 10 and 11. FIG. 13 is a diagram illustrating a modification in which the low-heat generating switching element 131 and the high-heat generating switching element 132 are different in position on the circuit.

In the modification illustrated in FIG. 13, one (for example, the high-heat generating switching element 132) of the low-heat generating switching element 131 and the high-heat generating switching element 132 is the high-side switching elements 113H, . . . , and 118H, and the other opposite to the one (for example, the low-heat generating switching element 131) is the low-side switching elements 113L, . . . , and 118L. In the case of such a modification, heat generation of the switching elements is shared in side unit.

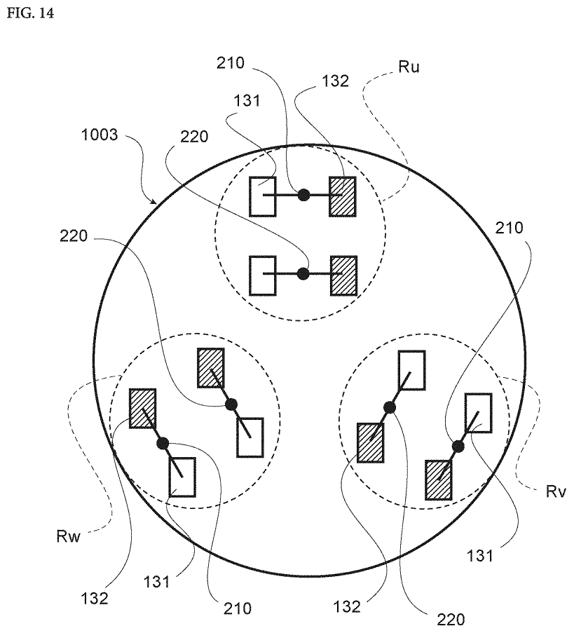

Also in the modification illustrated in FIG. 13, the low-heat generating switching element 131 performs the between-ON/OFF operation, and the high-heat generating switching element 132 performs the switching operation according to the PWM control. In addition, also in this modification, the switching element 131 that performs the between-ON/OFF operation is connected to the high-heat generating switching element 132 via the winding of the motor 200, and a current controlled by switching the high-heat generating switching element 132 flows. Since the switching operation is different between one side and the other side across the winding of the motor 200, heat generation sharing between the switching elements is realized. In addition, since the between-ON/OFF operation is performed on one side of the winding of the motor 200, the amount of heat generated by the motor drive unit 1000 is smaller than that in the related art. The mounting positions of the switching elements 131 and 132 in such modifications will be described below. FIG. 14 is a diagram schematically illustrating an example of mounting positions of the switching elements 131 and 132 in the modification illustrated in FIG. 13.

As in the modification illustrated in FIG. 9, in the modification illustrated in FIG. 14, the U-phase switching elements 131 and 132 are collectively mounted on the U-phase mounting position Ru, the V-phase switching elements 131 and 132 are collectively mounted on the V-phase mounting position Rv, and the W-phase switching elements 131 and 132 are collectively mounted on the W-phase mounting position Rw. Then, the phases are isotropically mounted to each other.

The three mounting positions Ru, Rv, and Rw are annularly disposed along the outer edge of the substrate 1003. In the four switching elements 131 and 132 mounted on each of the mounting positions Ru, Rv, and Rw, both the arrangement of the low-heat generating switching elements 131 and the arrangement of the high-heat generating switching elements 132 are directed from the outer edge to the central portion of the substrate 1003. The low-heat generating switching element 131 and the high-heat generating switching element 132 are disposed in an annular direction along the outer edge of the substrate 1003.

When viewed in an annular direction around the three mounting positions Ru, Rv, and Rw along the outer edge of the substrate 1003, the low-heat generating switching element 131 and the high-heat generating switching element 132 are alternately mounted. The order of mounting in the annular direction is alternate mounting for the individual switching elements 131 and 132 and for the set of low-heat generating switching elements 131 and the set of high-heat generating switching elements 132 in each phase.

Unlike the modification illustrated in FIG. 9, in the modification illustrated in FIG. 14, the low-heat generating switching element 131 and the high-heat generating switching element 132 are mounted with the connection point at which one end 210 of the coil of the motor is connected to the substrate 1003 interposed therebetween. Also for the connection point at which the other end 220 of the coil of the motor is connected to the substrate 1003, the low-heat generating switching element 131 and the high-heat generating switching element 132 are mounted with the connection point interposed therebetween.

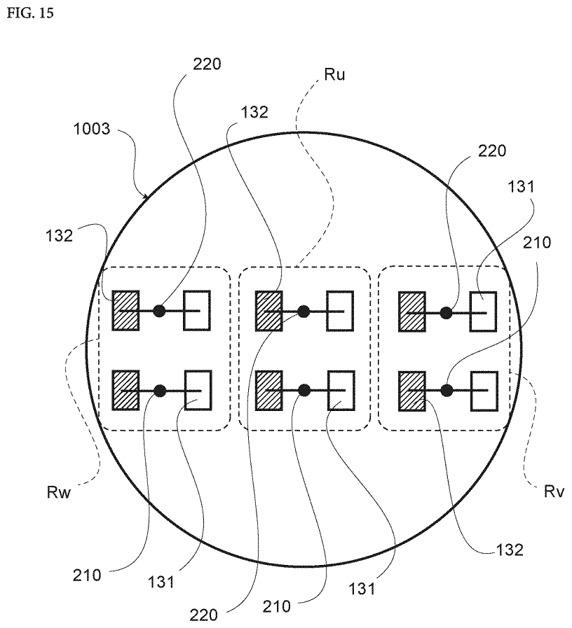

As described above, even when the low-heat generating switching element 131 and the high-heat generating switching element 132 have different positions on the circuit, the mounting arrangement similar to that in the modification illustrated in FIG. 9 can be employed for the mounting positions of the low-heat generating switching element 131 and the high-heat generating switching element 132 on the substrate 1003. When the low-heat generating switching element 131 and the high-heat generating switching element 132 are alternately mounted on the substrate 1003, heat distribution is leveled on the substrate 1003, and heat is efficiently dissipated via a heat sink or the like. FIG. 15 is a diagram schematically illustrating an example of linear mounting positions of the switching elements 131 and 132 in the modification illustrated in FIG. 13.

As in the modification illustrated in FIG. 10, in the modification illustrated in FIG. 15, the U-phase switching elements 131 and 132 are collectively mounted on the U-phase mounting position Ru, the V-phase switching elements 131 and 132 are collectively mounted on the V-phase mounting position Rv, and the W-phase switching elements 131 and 132 are collectively mounted on the W-phase mounting position Rw. The three mounting positions Ru, Rv, and Rw are disposed in a linear direction (that is, the left-right direction in the drawing) on the substrate 1003.

In the four switching elements 131 and 132 mounted on each of the mounting positions Ru, Rv, and Rw, the arrangement of the low-heat generating switching element 131 and the high-heat generating switching element 132 is oriented in the linear direction in which the three mounting positions Ru, Rv, and Rw are disposed. Both the arrangement of the low-heat generating switching elements 131 and the arrangement of the high-heat generating switching elements 132 are oriented in a direction intersecting the linear direction (that is, the vertical direction in the drawing).

When viewed in the linear direction, the low-heat generating switching element 131 and the high-heat generating switching element 132 are alternately mounted. The order of mounting in the linear direction is alternate mounting for the individual switching elements 131 and 132, and for the set of low-heat generating switching elements 131 and the set of high-heat generating switching elements 132 in each phase.

Unlike the modification illustrated in FIG. 10, in the modification illustrated in FIG. 15, the low-heat generating switching element 131 and the high-heat generating switching element 132 are mounted with the connection point at which one end 210 of the coil of the motor is connected to the substrate 1003 interposed therebetween. Also for the connection point at which the other end 220 of the coil of the motor is connected to the substrate 1003, the low-heat generating switching element 131 and the high-heat generating switching element 132 are mounted with the connection point interposed therebetween.

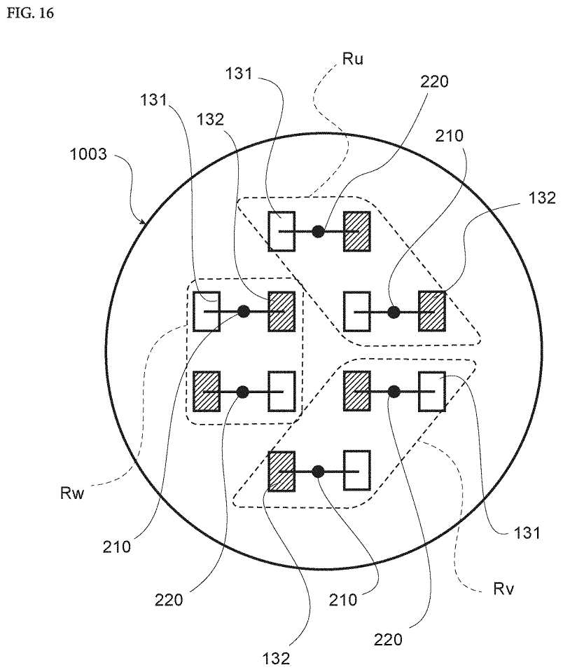

When the low-heat generating switching element 131 and the high-heat generating switching element 132 are alternately mounted on the substrate 1003 as in the modification illustrated in FIG. 15, heat distribution is leveled on the substrate 1003, and heat is efficiently dissipated via a heat sink or the like. FIG. 16 is a diagram schematically illustrating an example of two-dimensional mounting positions of the switching elements 131 and 132 in the modification illustrated in FIG. 13.

As in the modification illustrated in FIG. 12, in the modification illustrated in FIG. 16, the mounting positions Ru, Rv, and Rw of the switching elements 131 and 132 of the U-phase, the V-phase, and the W-phase are not uniform on the substrate 1003. However, focusing on the individual switching elements 131 and 132, the low-heat generating switching element 131 and the high-heat generating switching element 132 are alternately mounted in the left-right direction of the drawing and the vertical direction of the drawing. That is, the low-heat generating switching element 131 and the high-heat generating switching element 132 are two-dimensionally and alternately mounted.

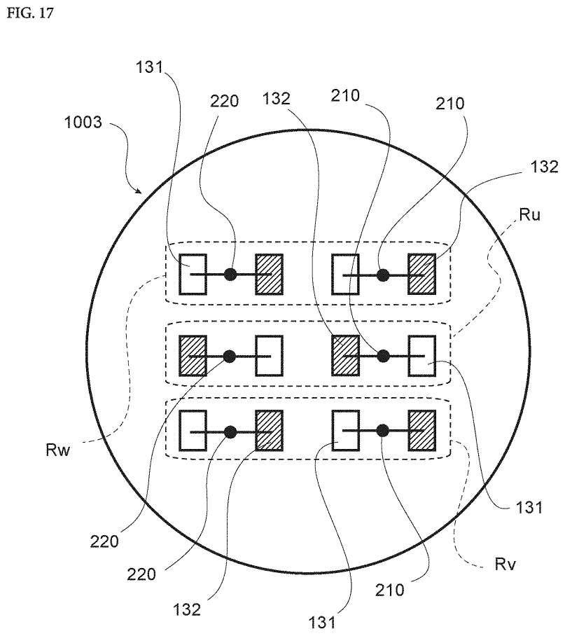

In the modification illustrated in FIG. 16, the distance between the low-heat generating switching element 132 and the high-heat generating switching element 131 in the different phases is shorter than the distance the between high-heat generating switching elements 132 in the different phases. With the mounting arrangement of the switching elements 131 and 132 illustrated in FIG. 16, the heat distribution on the substrate 1003 is further leveled than that in modifications illustrated in FIGS. 14 and 15. FIG. 17 is a diagram schematically illustrating another example of two-dimensional mounting positions of the switching elements 131 and 132 in the modification illustrated in FIG. 13.

In the modification illustrated in FIG. 17, the U-phase switching elements 131 and 132 are linearly mounted in the left-right direction of the drawing at the U-phase mounting position Ru, the V-phase switching elements 131 and 132 are linearly mounted in the left-right direction of the drawing at the V-phase mounting position Rv, and the W-phase switching elements 131 and 132 are linearly mounted in the left-right direction of the drawing at the W-phase mounting position Rw. The three mounting positions Ru, Rv, and Rw are positioned side by side in the vertical direction of the drawing on the substrate 1003.

Furthermore, the connection points at each of which one end 210 of the coil of the motor is connected to the substrate 1003 are disposed in the vertical direction in the drawing, and the connection points at each of which the other end 220 of the coil of the motor is connected to the substrate 1003 are also disposed in the vertical direction in the drawing.

In the four switching elements 131 and 132 mounted on the mounting positions Ru, Rv, and Rw, the low-heat generating switching element 131 and the high-heat generating switching element 132 are alternately mounted in each of the mounting positions Ru, Rv, and Rw. In addition, since the low-heat generating switching element 131 and the high-heat generating switching element 132 are disposed in the reverse order at the mounting positions Ru, Rv, and Rw adjacent to each other, the low-heat generating switching element 131 and the high-heat generating switching element 132 are alternately mounted when viewed in the vertical direction of the diagram in which the three mounting positions Ru, Rv, and Rw are disposed side by side.

That is, also in the modification illustrated in FIG. 17, the low-heat generating switching element 131 and the high-heat generating switching element 132 are two-dimensionally alternately mounted. The distance between the low-heat generating switching element 132 and the high-heat generating switching element 131 in the different phases is shorter than the distance between the high-heat generating switching elements 132 in the different phases. With the mounting arrangement of the switching elements 131 and 132 illustrated in FIG. 17, the thermal distribution is leveled on the substrate 1003, and the relative structure between the phases is linear and regular.

In any of the modifications and the mounting arrangement examples described above, high heat dissipation efficiency is realized by alternately mounting the switching elements 131 and 132. In addition, since the heat dissipation efficiency in the circuit on the substrate 1003 corresponding to the power conversion device is high, miniaturization and high output of the mechanically and electrically integrated motor corresponding to the drive device are realized.

Vehicles such as automobiles are generally equipped with a power steering device. A power steering device generates an auxiliary torque for assisting the steering torque of the steering system generated by the driver operating the steering handle. The auxiliary torque is generated by the auxiliary torque mechanism, and the burden on the driver's operation can be reduced. For example, the auxiliary torque mechanism includes a steering torque sensor, an ECU, a motor, a deceleration mechanism, and the like. The steering torque sensor detects the steering torque in the steering system. The ECU generates a drive signal based on the detection signal of the steering torque sensor. The motor generates an auxiliary torque according to the steering torque based on the drive signal, and transmits the auxiliary torque to the steering system via the deceleration mechanism.

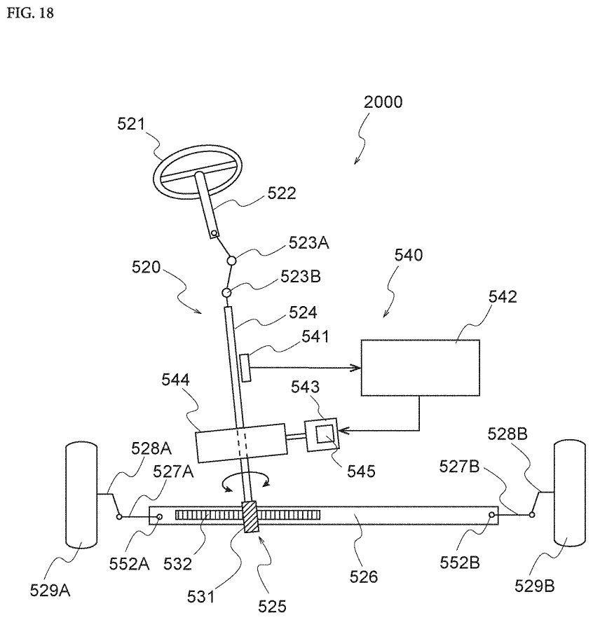

The motor drive unit 1000 of the above embodiment is suitably used for a power steering device. FIG. 18 is a diagram schematically illustrating a configuration of an electric power steering device 2000 according to the present embodiment. The electric power steering device 2000 includes a steering system 520 and an auxiliary torque mechanism 540.

The steering system 520 includes, for example, a steering handle 521, a steering shaft 522 (also referred to as a “steering column”), free shaft joints 523A and 523B, and a rotation shaft 524 (also referred to as a “pinion shaft” or “input shaft”).

The steering system 520 also includes, for example, a rack-and-pinion mechanism 525, a rack shaft 526, left and right ball joints 552A and 552B, tie rods 527A and 527B, knuckles 528A and 528B, and left and right steering wheels (for example, left and right front wheels) 529A and 529B.

The steering handle 521 is connected to the rotation shaft 524 via the steering shaft 522 and the free shaft joints 523A and 523B. The rack shaft 526 is connected to the rotation shaft 524 via the rack-and-pinion mechanism 525. The rack-and-pinion mechanism 525 has a pinion 531 provided to the rotation shaft 524 and a rack 532 provided to the rack shaft 526. The right steering wheel 529A is connected to the right end of the rack shaft 526 via the ball joint 552A, the tie rod 527A and the knuckle 528A in this order. Similar to the right side, the left steering wheel 529B is connected to the left end of the rack shaft 526 via the ball joint 552B, the tie rod 527B and the knuckle 528B in this order. Here, the right side and the left side correspond to the right side and the left side as seen from the driver sitting on the seat, respectively.

According to the steering system 520, steering torque is generated when the driver operates the steering handle 521, and is transmitted to the left and right steering wheels 529A and 529B via the rack-and-pinion mechanism 525. As a result, the driver can operate the left and right steering wheels 529A and 529B.

The auxiliary torque mechanism 540 includes, for example, a steering torque sensor 541, an ECU 542, a motor 543, a deceleration mechanism 544, and a power supply device 545. The auxiliary torque mechanism 540 applies auxiliary torque to the steering system 520 from the steering handle 521 to the left and right steering wheels 529A and 529B. The auxiliary torque is sometimes referred to as “additional torque”.

As the ECU 542, for example, the control circuits 301 and 302 shown in FIG. 1 and elsewhere are used. Further, as the power supply device 545, for example, the inverters 101 and 102 shown in FIG. 1 and elsewhere are used. Further, as the motor 543, for example, the motor 200 shown in FIG. 1 and elsewhere is used. In a case where the ECU 542, the motor 543, and the power supply device 545 constitute a unit generally referred to as a “mechanically and electrically integrated motor”, the structures illustrated in FIGS. 7 and 8 are suitably employed.

Of the elements shown in FIG. 18, the mechanism configured of the elements excluding the ECU 542, the motor 543, and the power supply device 545 corresponds to an example of the power steering mechanism driven by the motor 543.

The steering torque sensor 541 detects the steering torque of the steering system 520 applied by the steering handle 521. The ECU 542 generates a drive signal for driving the motor 543 based on a detection signal from the steering torque sensor 541 (hereinafter, referred to as a “torque signal”). The motor 543 generates an auxiliary torque according to the steering torque based on the drive signal. The auxiliary torque is transmitted to the rotation shaft 524 of the steering system 520 via the deceleration mechanism 544. The deceleration mechanism 544 is, for example, a worm gear mechanism. Auxiliary torque is further transmitted from the rotation shaft 524 to the rack-and-pinion mechanism 525.

The power steering device 2000 is classified into a pinion assist type, a rack assist type, a column assist type, or the like, depending on the part where the auxiliary torque is applied to the steering system 520. FIG. 18 shows the power steering device 2000 of the pinion-assist type. However, the power steering device 2000 is also applied to the rack assist type, the column assist type, and the like.

Not only a torque signal but also a vehicle speed signal, for example, can be input to the ECU 542. The microcontroller of the ECU 542 can PWM control the motor 543 based on the torque signal, the vehicle speed signal, and the like.

The ECU 542 sets a target current value at least based on the torque signal. It is preferable that the ECU 542 sets the target current value in consideration of the vehicle speed signal detected by the vehicle speed sensor and further in consideration of the rotation signal of the rotor detected by the angle sensor. The ECU 542 can control the drive signal of the motor 543, i.e., the drive current thereof so that the actual current value detected by the current sensor (refer to FIG. 1) coincides with the target current value.

According to the power steering device 2000, the left and right steering wheels 529A and 529B can be operated by the rack shaft 526 by utilizing the combined torque obtained by adding the auxiliary torque of the motor 543 to the steering torque of the driver. Specifically, by including the motor drive unit 1000 of the above embodiment, the motor drive unit 1000 is downsized and increased in output, and space saving and stabilization of assist power in the power steering device 2000 are realized.

In the above description, an example is described in which power is supplied to the motor in which the windings of phases are not connected to each other by the inverter connected to both ends of the windings. However, the power conversion device and the drive device of the present invention may supply power to the motor by, for example, a single inverter, or may supply power to, for example, a double star motor. When power is supplied to the double star motor, for example, a high-heat generating switching element may supply power to one of the double stars, and a low-heat generating switching element may supply power to the other of the double stars.

In the above, a power steering device is mentioned as an example of the usage in the power conversion device and the drive device of the present invention, but the usage of the power conversion device and the drive device of the present invention is not limited to those described above. It is applicable to a wide range including a pump and a compressor.

It is to be considered that the embodiments described above are illustrative in all aspects, and are not restrictive. The scope of the present invention is shown not by the embodiments described above but by the claims, and it is intended that all modifications within the meaning and scope equivalent to the scope of the claims are included.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A power conversion device that converts power from a power source to supply the converted power to a motor,
the power conversion device comprising:
an inverter connected to a winding of the motor and including a first switching element that generates heat in association with an operation of power control and a second switching element that generates more heat than the first switching element in association with an operation of power control; and
a substrate on which the first switching element and the second switching element are mounted, wherein a first element group including one or a plurality of the first switching elements and a second element group including one or a plurality of the second switching elements are alternately mounted on the substrate.

2. The power conversion device according to claim 1, wherein the second switching element performs switching by PWM control, and
the first switching element maintains one of an ON state and an OFF state while the second switching element performs a switching operation a plurality of times.

3. The power conversion device according to claim 2, wherein the inverter includes a first inverter connected to one end of a winding of the motor and a second inverter connected to another end opposite to the one end, and wherein the first switching element is connected to the second switching element via the winding, and a current controlled by switching the second switching element flows.

4. The power conversion device according to claim 1, wherein the inverter includes a first inverter connected to one end of a winding of the motor and a second inverter connected to another end opposite to the one end, and wherein the first switching element is provided in one of the first inverter and the second inverter, and the second switching element is provided in the other opposite to the one.

5. The power conversion device according to claim 1, wherein one of the first switching element and the second switching element is a high-side switching element connected to the winding and a power source end, and the other opposite to the one is a low-side switching element connected to the winding and a ground end.

6. The power conversion device according to claim 1, further comprising a heat sink that is in direct or indirect contact with both the first switching element and the second switching element to dissipate heat.

7. The power conversion device according to claim 1, wherein the first element group and the second element group are alternately arranged and mounted along an annular arrangement direction on the substrate.

8. The power conversion device according to claim 1, wherein the first element group and the second element group are alternately arranged and mounted along a linear arrangement direction on the substrate.

9. The power conversion device according to claim 1, wherein the first element group and the second element group are alternately arrayed and mounted in a two-dimensional array on the substrate.

10. A drive device comprising:
the power conversion device according to claim 1; and
a motor to which power converted by the power conversion device is supplied.

11. The drive device according to claim 10, wherein at least one of a housing that houses the motor and a holder of a bearing that holds a rotation shaft of the motor serves as a heat sink that is in direct or indirect contact with both the first switching element and the second switching element to dissipate heat.

12. A power steering device comprising:
the power conversion device according to claim 1;
a motor to which power converted by the power conversion device is supplied; and
a power steering mechanism driven by the motor.
